(19) United States
(12) Patent Application Publication
(10) Pub. No.: US 2012/0061051 A1
(43) Pub. Date: Mar. 15, 2012

(54) DISPENSER HEATER FOR AN APPLIANCE

(75) Inventors: Alan Joseph Mitchell, Louisville, KY (US); Andrew Reinhard Krause, LaGrange, KY (US); Lorina June White, Louisville, KY (US)

(73) Assignee: GENERAL ELECTRIC COMPANY, Schenectady, NY (US)

(21) Appl. No.: 12/946,297

(22) Filed: Nov. 15, 2010

(51) Int. Cl. F25B 29/00; B67D 7/82

(52) U.S. Cl. 165/64; 222/146.5

(57) ABSTRACT

A dispenser heater for an appliance such as a refrigerator is provided. A heating element is used to raise the temperature of a dispenser component above the dew point of ambient air so as to prevent condensation. The heating element is embedded within the dispenser component to improve heat transfer and prevent displacement during manufacture of the refrigerator.

### FIELD OF THE INVENTION

The present invention relates to a dispenser heater for an appliance, such as a refrigerator, wherein a heating element is used to raise the temperature of a dispenser component above the dew point.

### BACKGROUND OF THE INVENTION

One challenge in the design of modern refrigerators is the prevention of condensation on the outside of the cabinet. Condensation results from portions of the outside surface of the refrigerator cabinet being at a temperature below the dew point temperature of the surrounding air. The lower temperature of these outside surfaces is a result of the transfer of thermal energy between the inside of the refrigerator and the outside, which can occur e.g., by conduction, the movement of cold air caused by opening and closing the interior of the refrigerator, and/or the movement of air across gaskets and other seals. Moisture in the air will condense on those colder portions of the cabinet if the temperature reaches the dew point. If such condensation continues, water will eventually accumulate and/or run onto the floor where the appliance is located.

Most commonly such condensation occurs on the front face, and to a lesser degree, on the front portion of the outer case side and top walls adjacent the front edge of the case. It also can occur on the peripheral edges or walls of the doors, particularly the adjacent facing walls of the doors of multi-compartment units. Another location where condensation can occur is in a dispenser recess of an appliance. For example, the dispenser may include a door for the delivery of ice from the interior of the refrigerator. The door opens to allow ice to be conveyed and, at the same time, cold air from the interior of the refrigerator will also pass through the opened door. Additionally, while the refrigerator cabinet may be insulated, it may not be practical to insulate the door and/or all portions of the walls of the dispenser. Thus, some cooling may result from conduction as well. As a result, certain components of the dispenser such as the opening around the ice chute, the walls of the dispenser, and other dispenser features can become cooled below the dew point temperature of ambient air on the outside of the refrigerator—resulting in condensation.

Conventionally, the condensation problem may be solved by applying additional heat to a particular surface—thereby raising the temperature above the dew point of the surrounding air to prevent condensation. In some refrigerators this is accomplished by placement of an electric heater at a position adjacent and along the inside surface of the wall or component needing heat. Other refrigerators may use heated refrigerant in a loop from the refrigeration cycle to heat the problematic wall or component.

Several problems can occur with these approaches. By way of example, placing a heat source along the inside surface of e.g., a dispenser wall requires that enough thermal energy is provided to pass through the entire dispenser wall to heat its outside surface. Additionally, in the manufacture of refrigerators, a foamed-in insulation is frequently applied to the inside of various surfaces to help prevent heat transfer that cools the exterior of the cabinet. During manufacture, the insertion of this insulation may unintentionally displace a heating element such as an electric strip so that the outside surface is not sufficiently heated above the dew point.

Accordingly, a dispenser heater that provides greater efficiency in heating one or more components of the dispenser would be useful. Such a dispenser heater that can be readily installed during manufacture in a manner that ensures the proper positioning of the heater would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a refrigerator having a heated dispenser. The refrigerator includes an exterior wall defining a dispenser recess. A dispenser component is positioned at the dispenser recess of the exterior wall. The dispenser component includes a moldable material configured for use with the dispenser. A heating element is contained within the moldable material. The heating element is configured for raising the temperature of the dispenser component above the dew point of ambient air in contact with the dispenser.

In another exemplary embodiment, the present invention provides a dispenser heater for a dispenser of an appliance. The dispenser heater includes a dispenser component positioned near a dispenser of the appliance. A heating element is embedded within the dispenser component and is configured for heating the dispenser component to prevent condensation on the dispenser.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a front, perspective view of an exemplary embodiment of a refrigerator having a heated dispenser according to the present invention.

FIG. 2 is another front, perspective view of the refrigerator of FIG. 1 with both doors open to show the interior.

FIG. 3 is a close-up view of an exemplary dispenser in a dispenser recess of the refrigerator of FIG. 1.

FIG. 4 is a cross-sectional view of the exemplary dispenser and recess taken along line 4-4 of FIG. 3.

FIG. 5 is a rear view of an exemplary embodiment of a dispenser of the present invention.

FIG. 6 is a perspective view of a dispenser component for providing heat at the opening of a dispenser.

### DETAILED DESCRIPTION OF THE INVENTION

The present invention relates to a dispenser heater for an appliance such as a refrigerator. A heating element is used to raise the temperature of a dispenser component above the dew point of ambient air so as to prevent condensation. The heating element is embedded within the dispenser component in order to improve heat transfer and prevent displacement during manufacture of the refrigerator. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

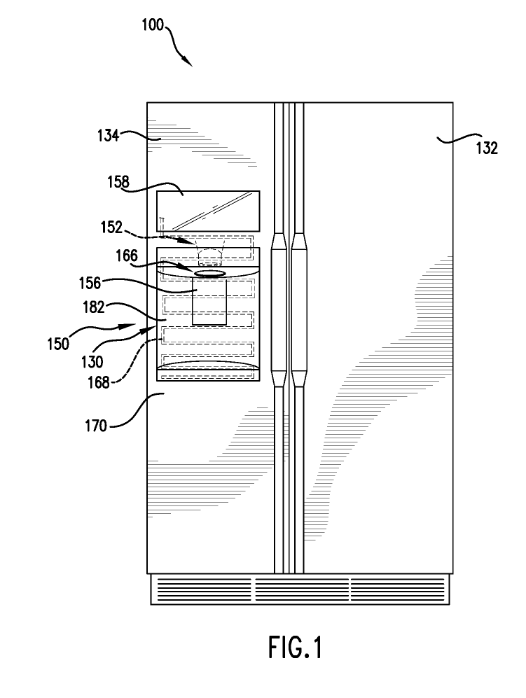

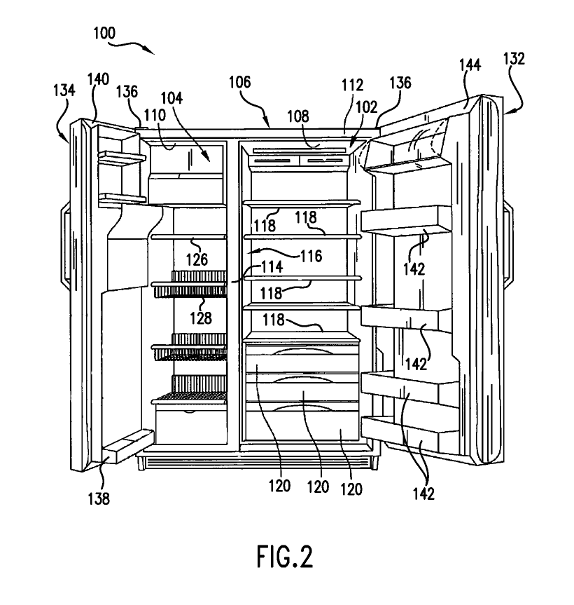

FIGS. 1 and 2 provide front views of a representative side-by-side refrigerator 100 incorporating an exemplary embodiment of a dispenser heater of the present invention. For illustrative purposes, the present invention is described with a refrigerator 100 having a construction as shown and described further below. As used herein, a refrigerator includes appliances such as a freezer, refrigerator/freezer combination, over-and-under types, and any other style or model of a refrigerator. Accordingly, other configurations including multiple and different styled compartments could be used with refrigerator 100, it being understood that the configuration shown in FIGS. 1 and 2 is by way of example only.

Referring further to FIG. 2, refrigerator 100 includes a fresh food storage compartment 102 and a freezer storage compartment 104 arranged side-by-side and contained within an outer case 106 and inner liners 108 and 110. A space between outer case 106 and inner liners 108 and 110, and between inner liners 108 and 110, is filled with foamed-in-place insulation. Outer case 106 normally is formed by folding a sheet of a suitable material, such as pre-painted steel, into an inverted U-shape to form top and side walls of case. A bottom wall of outer case 106 normally is formed separately and attached to the case side walls and to a bottom frame that provides support for refrigerator 100.

Inner liners 108 and 110 are molded from a suitable plastic material to form fresh food storage compartment 102 and freezer storage compartment 104, respectively. Alternatively, inner liners 108, 110 may be formed by bending and welding a sheet of a suitable metal, such as steel. The illustrative embodiment includes two separate inner liners 108, 110 as it is a relatively large capacity unit and separate liners add strength and are easier to maintain within manufacturing tolerances. In smaller refrigerators, a single liner is formed and a mullion spans between opposite sides of the liner to divide it into a freezer storage compartment and a fresh food storage compartment.

A breaker strip 112 extends between a case front flange and outer front edges of inner liners 108, 110. Breaker strip 112 is formed from a suitable resilient material, such as an extruded acrylo-butadiene-styrene based material (commonly referred to as ABS).

The insulation in the space between inner liners 108, 110 is covered by another strip of suitable resilient material, which also commonly is referred to as a mullion 114. Mullion 114 also preferably is formed of an extruded ABS material. Breaker strip 112 and mullion 114 form a front face, and extend completely around inner peripheral edges of outer case 106 and vertically between inner liners 108, 110. Mullion 114, insulation between compartments, and a spaced wall of liners separating compartments, sometimes are collectively referred to herein as a center mullion wall 116.

Shelves 118 and slide-out drawers 120 normally are provided in fresh food storage compartment 102 to support items being stored therein. Additionally, at least one shelf 126 and at least one wire basket 128 are also provided in freezer storage compartment 104 of the exemplary embodiment of FIGS. 1 and 2.

Fresh food door 132 and freezer door 134 close access openings to fresh food storage compartment 102 and freezer storage compartment 104, respectively. Each door 132, 134 is mounted by a top hinge 136 and a bottom hinge (not shown) to rotate about its outer vertical edge between an open position, as shown in FIG. 2, and a closed position (as shown in FIG. 1) closing the associated storage compartment. In the exemplary embodiment, freezer door 134 includes a plurality of storage shelves 138 and a sealing gasket 140 and fresh food door 132 includes a plurality of storage shelves 142 and a sealing gasket 144.

As will be understood by one of ordinary skill in the art, refrigerator 100 also includes a machinery compartment (not shown) that at least partially contains components for executing a known vapor compression cycle for cooling air. The components include a compressor (not shown), a condenser (not shown), an expansion device (not shown), and an evaporator (not shown) connected in series and charged with a refrigerant. The evaporator is a type of heat exchanger which transfers heat from air passing over the evaporator to a refrigerant flowing through the evaporator, thereby causing the refrigerant to vaporize. The cool air is used to refrigerate one or more refrigerator or freezer compartments via fans (not shown). Collectively, the vapor compression cycle components in a refrigeration circuit, associated fans, and associated compartments are referred to herein as a sealed system. The construction of the sealed system is well known and therefore not described in detail herein, and the sealed system is operable to force cold air through the refrigerator.

Referring now to FIGS. 1, 3, and 4, refrigerator 100 includes a dispenser 150 located within a recess 130 on freezer door 134. More particularly, dispenser 150 includes a chute 176 for an ice dispenser 152 and could include other features such as e.g., a water dispenser. These features can be controlled use touch pad 158. Recess 130 is defined by exterior wall 170, which in turn forms part of the exterior surface of freezer door 134. Pressure switch 156 provides for the activation of ice dispenser 152. Using the teachings disclosed herein, it will be understood that other configurations and locations of dispenser 150 may also be used with the present invention.

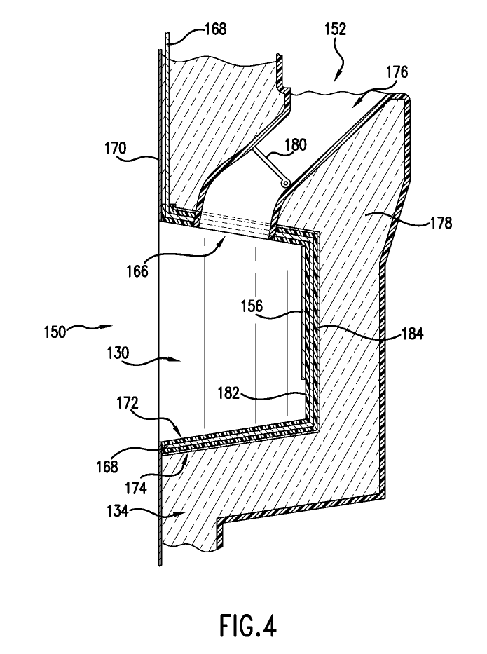

Dispenser 150 includes a dispenser wall 182 that is received into recess 130. During use of the refrigerator 100, dispenser wall 182 remains in contact with ambient air—i.e. air located outside of case 106. If outside surface 172 of dispenser wall 182 does not remain at a temperature above the dew point of the ambient air, water will form on outside surface 172 from moisture in the ambient air condensing when such air reaches the dew point. By way of example, outside surface 172 can be particularly problematic due to contact with cold air from inside the freezer storage compartment 104. As shown in FIG. 4, during operation of ice dispenser 152, door 180 opens to allow ice to travel down chute 176 and through opening 166. Cold air will also move down chute 176 and thereby come into contact with outside surface 172.

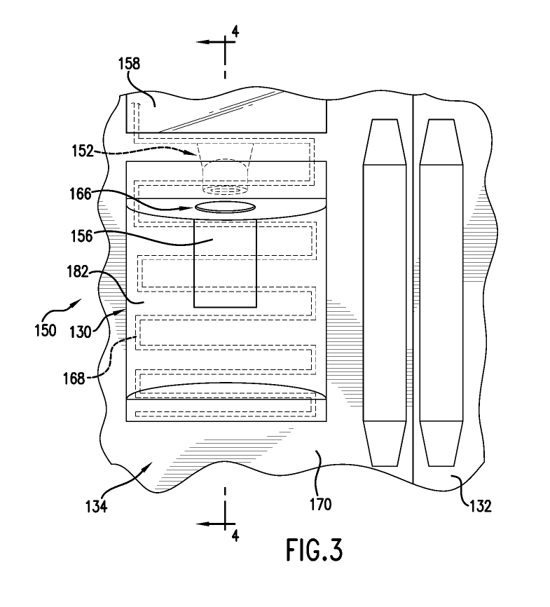

Accordingly, a heating element 168 is embedded in dispenser wall 182. As shown in FIG. 3, heating element 168 is positioned in a zig-zag manner in an effort to provide sufficient heat to all of outside surface 172 of dispenser wall 182. For this exemplary embodiment, heating element 168 is constructed from a loop of resistive wire that becomes heated upon the flow of an electrical current therethrough. The resistive wire of heating element 168 is embedded within dispenser wall 182, which in turn is preferably constructed from a moldable material that can be overmolded onto heating element 168. For example, dispenser wall 182 may be constructed from a thermoplastic material.

By embedding heating element 168, it remains in the correct position during the manufacture of refrigerator 100. For example, insulation 178 is of a foamed-in type that can expand and unintentionally reposition a wire or other element attached to inside surface 174, which could lead to insufficient heating of dispenser wall 182. Such possibility is eliminated by the permanency of embedding heating element 168.

To assist in providing heat energy over dispenser wall 182, a thermally conductive layer 184 may be added between inside surface 174 and insulation 178. Thermally conductive layer 184 is constructed from a thin sheet of material that is adhered to, and in substantial contact with, inside surface 174 so as to provide heat exchange with dispenser wall 182. Accordingly, as heating element 168 provides heat energy to dispenser wall 182, such heat will be conducted to thermally conductive layer 184, which will help facilitate the distribution of such heat over dispenser wall 182 to raise its temperature. Preferably, layer 184 is highly thermally conductive, being constructed from a thin sheet of material such as a metal foil having a thermal conductivity between about 60 and 230 BTU's per hour/foot/degree Fahrenheit. Such metal foil can be very thin having, for example, a thickness of between about 0.005 and 0.05 inch.

Alternatively, thermally conductive layer 184, dispenser wall 182, or both can be constructed from a thermoplastic material that contains a thermally conductive filler such as e.g., a metal powder. The thermally conductive filler will enhance heat transfer in a manner similar to the use of a thin metal foil. Specifically, heat from heating element 168 will be further distributed over dispenser wall 182 to raise its temperature.

FIG. 5 illustrates another exemplary embodiment where a heating element 268 is embedded within a ring 286 positioned around the opening 266 for a dispenser 250. The view in FIG. 5 is of the inside of dispenser 250 i.e., the portion that would be positioned within the cabinet or case of a refrigerator. Details such as the door or chute are not shown in FIG. 5 for purposes of illustrating heating element 268 more clearly. As previously indicated, dispenser 250 will become cooled around opening 266 during use, which could result in condensation.

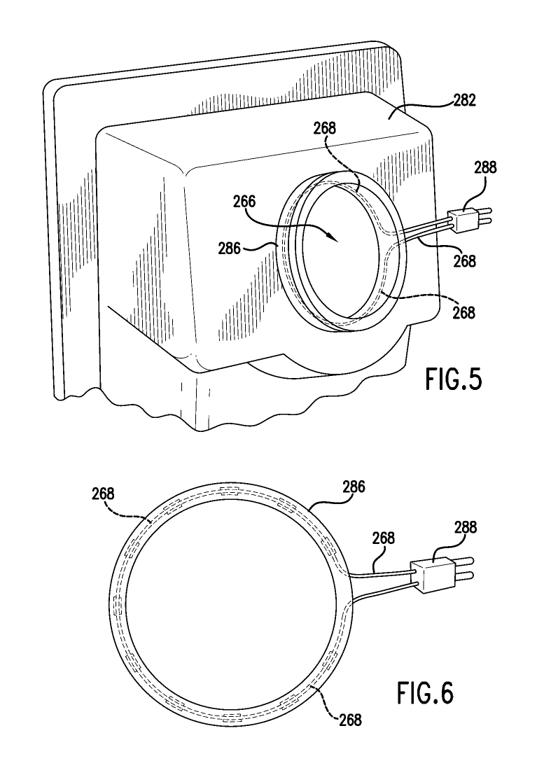

Accordingly, heating element 268 is constructed as e.g., a resistive wire that is embedded within ring 286 that is positioned at opening 266. By way of example, heating element 268 could be constructed from over-molding a thermoplastic around heating element 268 in a manner that provides for centering element 268 within ring 268 as shown in FIG. 6. For example, a mold can be constructed that includes clips or other features for ensuring that heating element 268 remains substantially centered. Heating element 286 includes a plug 288 for connection to a power supply.

As shown in FIG. 5, ring 286 is affixed to dispenser 250. A variety of techniques may be used to position ring 286 at dispenser opening 266. For example, ring 286 could be formed with dispenser 250, adhered to dispenser 250, provided with a snap-fit connection, and/or other techniques may be used as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator having a heated dispenser, comprising:
an exterior wall defining a dispenser recess;
a dispenser component positioned at the dispenser recess of said exterior wall, said dispenser component comprising:
a moldable material configured for use with the dispenser; and,
a heating element contained within said moldable material, said heating element configured for raising the temperature of said dispenser component above the dew point of ambient air in contact with the dispenser.

2. A refrigerator having a heated dispenser as in claim 1, wherein said dispenser component is a dispenser wall, and wherein said heating element is positioned so as to raise an exterior surface of said dispenser wall above the dew point of ambient air in contact therewith.

3. A refrigerator having a heated dispenser as in claim 2, further comprising a thin sheet of material having a high thermal conductivity positioned in substantial surface contact with an inside surface of said dispenser wall and proximate to said heating element.

4. A refrigerator having a heated dispenser as in claim 3, wherein said thin sheet of material has a thermal conductivity between about 60 and 230 BTU's per hour/foot/degree Fahrenheit.

5. A refrigerator having a heated dispenser as set forth in claim 3, wherein said thin sheet of material is a metal foil having a thickness between about 0.005 and 0.05 inch.

6. A refrigerator having a heated dispenser as set forth in claim 3, wherein said thin sheet of material is formed from a metal selected from the group consisting of aluminum and copper.

7. A refrigerator having a heated dispenser as set forth in claim 6, wherein said thin sheet of material is a metal foil having a thickness between about 0.005 and 0.05 inch.

8. A refrigerator having a heated dispenser as set forth in claim 3, further comprising a layer of insulation positioned adjacent said thin sheet of material such that said thin sheet of material is located between said dispenser wall and said layer of insulation.

9. A refrigerator having a heated dispenser as set forth in claim 8, wherein said layer of insulation is foamed in place adjacent to said thin sheet of material.

10. A refrigerator having a heated dispenser as in claim 1, wherein said heating element comprises a resistive wire embedded within said moldable material.

11. A refrigerator having a heated dispenser as in claim 1, wherein the dispenser defines an opening for the delivery of ice, water, or both from the refrigerator, and wherein said dispenser component is positioned at the opening.

12. A dispenser heater for a dispenser of an appliance, comprising:
a dispenser component positioned at the dispenser of the appliance; and
a heating element embedded within said dispenser component and configured for heating said dispenser component to prevent condensation on the dispenser.

13. A dispenser heater for an appliance as in claim 12, wherein said dispenser component comprises a dispenser wall having an inside surface.

14. A dispenser heater for a dispenser of an appliance as in claim 13, further comprising a thin sheet of material having a high thermal conductivity positioned in substantial surface contact with the inside surface of said dispenser wall and proximate to said heating element.

15. A dispenser heater for a dispenser of an appliance as in claim 13, further comprising a thin sheet of material positioned into surface contact with the inside surface of said dispenser wall and proximate to said heating element, wherein said thin sheet of material has a thermal conductivity between about 60 and 230 BTU's per hour/foot/degree Fahrenheit.

16. A dispenser heater for a dispenser of an appliance as in claim 15, wherein said thin sheet of material is a metal foil having a thickness between about 0.005 and 0.05 inch.

17. A dispenser heater for a dispenser of an appliance as in claim 16, wherein said thin sheet of material is formed from a metal selected from the group consisting of aluminum and copper.

18. A dispenser heater for a dispenser of an appliance as in claim 14, wherein said thin sheet of material is a metal foil having a thickness between about 0.005 and 0.05 inch.

19. A dispenser heater for a dispenser of an appliance as in claim 12, where said heating element comprises a resistive wire.

20. A dispenser heater for a dispenser of an appliance as in claim 12, wherein the dispenser has an opening, and wherein said dispenser component defines the opening or is positioned at the opening.
